(19) United States
(12) Patent Application Publication
(10) Pub. No.: US 2014/0072163 A1
(43) Pub. Date: Mar. 13, 2014

(54) MICROSPEAKER DIAPHRAGM EDGE MEMBER, MICROSPEAKER DIAPHRAGM, MICROSPEAKER, AND ELECTRONIC DEVICE

(71) Applicant: Seigo Yamada, Tokyo (JP)

(72) Inventor: Seigo Yamada, Tokyo (JP)

(73) Assignee: AZUMA CHEMICAL CO., LTD., Tokyo (JP)

(21) Appl. No.: 14/110,321

(22) PCT Filed: Sep. 1, 2011
(86) PCT No.: PCT/JP2011/069940

§ 371 Date: Nov. 21, 2013

(30) Foreign Application Priority Data
Apr. 8, 2011 (JP) 2011-085942

(51) Int. Cl. H04R 1/00

(52) U.S. Cl. CPC H04R 1/00
USPC 381/354

(57) ABSTRACT

The invention provides a microspeaker diaphragm edge member having superior heat resistance, cold resistance, moisture resistance, formability, and high internal loss property, a diaphragm employing such a microspeaker diaphragm edge member, a microspeaker employing such a diaphragm, and an electronic device incorporating such a microspeaker. To constitute such an edge member, an intermediate layer featuring a high damping effect has a constraining layer of polyetheretherketone (PEEK) disposed on one face thereof and a constraining layer of either polyetheretherketone (PEEK) or polyetherimide (PEI) disposed on the other face thereof.

### TECHNICAL FIELD

The present invention relates to a microspeaker diaphragm edge member for electroacoustic transducers used in electronic devices such as mobile telephones, mobile audio equipment, and laptop PCs and, more particularly, to a microspeaker diaphragm edge member, which excels in heat resistance, cold resistance, moisture resistance, formability (moldability), and high internal loss property, a microspeaker diaphragm employing the microspeaker diaphragm edge member, a microspeaker employing the microspeaker diaphragm, and electronic devices such as mobile telephones, mobile audio equipment, and laptop PCs employing the microspeaker.

### BACKGROUND ART

Today the edge member serving also as the diaphragm of a microspeaker used in the above-mentioned small electronic devices such as mobile telephones comes in a diaphragm of unitary construction formed by a heated press molding of an engineering plastic, such as polyimide (PI), polyamide-imide (PAI), polyphenylene sulfide (PPS), polyetherimide (PEI), polyethylene naphthalate (PEN), polyethylene terephthalate (PET), or polyetheretherketone (PEEK). And an integrated molded product which combines inseparably the functions of the diaphragm body of an ordinary speaker diaphragm (also referred to as paper cone) and the edge member located around it is the mainstream.

A speaker diaphragm of a resin film of polyimide (PI) or polyamide-imide (PAI) cast into a dome shape is disclosed, for instance, in Japanese Unexamined Patent Application Publication No. 2003-289594 “Speaker Diaphragm and Polyamide Resin and Polyimide Resin Used Therefor” (Patent Document 1).

FIG. 6, FIG. 7, and FIG. 8 are a perspective illustration of a mobile telephone, a structural example of a diaphragm, and a configuration diagram of a speaker, respectively, disclosed in Patent Document 1.

FIG. 6 shows a mobile telephone 1 which includes a speaker section 2 (4) and a microphone section 3 (receiver speaker).

FIG. 7 is an overall view of a diaphragm molded from a polyamide-imide (PAI) resin film (or polyimide (PI) resin film). As shown in the figure, the diaphragm 3 includes a dome part (body) 3a thereof, a fitting cavity 3b thereof, a peripheral part (edge) 3c thereof, an outer bonding part 3d thereof, and a voice coil 5 of the speaker.

FIG. 8 is a diagram showing a structure of a speaker section incorporating a diaphragm 3 shown in FIG. 7. As shown in the figure, the speaker section includes a diaphragm 3, a dome part (body) 3a of the diaphragm, a fitting cavity 3b of the diaphragm, a peripheral part (edge) 3c of the diaphragm, an outer bonding part 3d of the diaphragm, a speaker 4 employing the diaphragm (corresponding to the speaker section 2 in FIG. 6), a voice coil 5, an upper pole plate 7a of the speaker, a lower pole plate 7b of the speaker, a magnetic gap 8, an external terminal 9 of the speaker, a gasket 10, a magnet 14 of the speaker, a magnetic circuit 15 of the speaker, a frame 17, and a protector 26.

In the example shown in FIGS. 6 to 8, a thin-film engineering plastic of polyimide-imide (PAI) (or polyimide (PI)) for lightweight design of the diaphragm is used in consideration of the desired efficiency and heat resistance of the speaker. However, it is difficult to design the engineering plastic diaphragm having the peripheral part (edge) and the dome part (body) formed integrally to have a lower lowest resonance frequency (F0) of the speaker. Hence, the diaphragm tends to have less than enough reproducible lower limit frequencies and produce harder sounds, thus failing to achieve required sensibility.

Against the backdrop of ubiquitous society with yearly progressing digitalization, there exists a dizzying variety of demands for mobile telephones as a representative device offering mobile functions. Accordingly, there are greater demands for wider band coverage including higher sensibility, higher output, and better sound quality of the microspeaker (about 20 mm in diameter) which is incorporated into mobile telephones.

It should be noted that the conventional diaphragm of a unitary construction must singly perform both the functions of the body part and the edge part if it is to hold the lowest resonance frequency (F0) low and carry out high-output operation.

The diaphragm body should preferably be made of material having a hardness of high Young's modulus if it is to propagate the vibrations of frequencies transmitted mainly from the voice coil fully and accurately into the air, thus helping reproduce sounds without distortion and easy to listen to.

On the other hand, the edge part is located around a vibrator body and fixed to the frame. Therefore, it should preferably be made of a material having a large internal loss property to efficiently and quickly absorb the vibration mainly from the diaphragm and capable of performing a flexible damper function like rubber.

However, there have been limitations in requiring a diaphragm of a unitary construction formed from a single film to satisfy both the strength of the body part and the softness or flexibility of the edge part like that of a damper.

With the rapid spread of the use of mobile telephones and other mobile devices in recent years, there are ever-increasing demands for higher output and better sound quality. In response to this trend, microspeaker models of separate type featuring hard diaphragm material and soft edge material are on the increase, and consequently material development therefor is of urgent necessity.

As for speaker diaphragms using multilayered materials, Japanese Unexamined Patent Application Publication No. 2004-31208 “Speaker Diaphragm and Speaker Using the Same” (Patent Document 2) discloses one having a polyimide resin based elastomer layer on one or both surfaces thereof with the purpose of realizing wider frequency characteristic and higher sound quality by lowered lowest resonance frequency (F0), and Japanese Patent No. 3996075 “Speaker Diaphragm Film” (Patent Document 3) discloses one having a resin coating layer on one or both surfaces of a polyetherimide film base material.

### CONVENTIONAL DOCUMENT

### Patent Document

Patent Document 1: Japanese Unexamined Patent Application Publication No. 2003-289594
Patent Document 2: Japanese Unexamined Patent Application Publication No. 2004-312085
Patent Document 3: Japanese Patent No. 3996075

### SUMMARY OF THE INVENTION

### Problem to be Solved by the Invention

An important function of a microspeaker diaphragm edge member is to stabilize the frequency characteristic by suppressing the occurrence of divided vibrations from the diaphragm. To achieve it, a function of efficiently damping the dynamic vibrations is required. The edge member is also required to have a high Young's modulus characteristic so as to transmit vibrations from the coil.

Also, in view of varied usage environments of mobile telephones and other electronic devices into which the microspeaker is incorporated, the microspeaker diaphragm edge member is required to have such physical properties as viscoelasticity, high internal loss, high stress resistance, heat resistance, cold resistance, flexibility, formability for mass production, and shape retention characteristic.

In response to yearly advancing higher output and slimmer design (e.g., smartphones), the physical properties required of the edge material are all higher-level properties than those of the above-described conventional microspeaker diaphragm edge members. In particular, both high heat resistance and flex resistance to prevent rupture under heat are required to realize higher output design, whereas excellent internal loss and stress performance and high Young's modulus are required to realize slimmer design.

Also, as mentioned above, there have been some proposals for the use of multilayered material instead of the conventional single-layer material. However, the constitutions thus far proposed do not provide sufficient heat and flex resistance to meet the higher output design, thus failing to fully satisfy the above-described requirements.

More specifically, the general-purpose materials, such as PAI, PI, and PEI as disclosed in the above Patent Documents, do not provide sufficient endurance against the high heat and strong vibration from the voice coil that may accompany higher output and better sound quality design of the speaker. As a result, they may break down within a shorter period of time.

Thus, in view of the foregoing circumstances, the purpose of the present invention is to provide a microspeaker diaphragm edge member excelling especially in heat resistance, cold resistance, moisture resistance, formability, flex resistance, vibration resistance, and high internal loss property, a microspeaker diagram employing such a microspeaker diaphragm edge member, a microspeaker employing such a microspeaker diagram, and electronic devices, such as mobile telephones, mobile audio equipment, and laptops, incorporating such a microspeaker.

### Means for Solving the Problem

A microspeaker diaphragm edge member according to the present invention includes an intermediate layer having a high damping effect, a constraining layer of polyetheretherketone (PEEK) disposed on one face of the intermediate layer, and a constraining layer of polyetheretherketone (PEEK) or polyetherimide (PEI) disposed on the other face of the intermediate layer. Also, the constraining layers on the respective faces of the intermediate layer are formed of PEEK, and the thickness of the constraining layers is both in a range of 2.0 to 20.0 μm. Also, the thickness of the intermediate layer is in a range of 5.0 to 50.0 μm. Also, the intermediate layer is formed of an acrylic or butyl low-hardness material. Further, the hardness of the intermediate layer is Shore A 60 or below.

A microspeaker diaphragm according to the present invention employs the above-described microspeaker diaphragm edge member. More specifically, the microspeaker diaphragm has a dome part (body part) formed of a highly-elastic member and a ring-shaped peripheral part (edge part) formed of the above-described microspeaker diaphragm edge member. And the dome part and the peripheral part are integrated with each other in such a positional relationship that the outer peripheral part of the highly-elastic member is overlapped with the inner peripheral part of the ring-shaped microspeaker diaphragm edge member. Or the microspeaker diaphragm has a highly-elastic member forming the dome part (body part) and a sheet-shaped microspeaker diaphragm edge member forming both the dome part (body part) and peripheral part (edge part) of the diaphragm. And the highly-elastic member and the edge member are integrated with each other in such position that the highly-elastic member overlaps the sheet-shaped microspeaker diaphragm edge member in the dome part (body part) of the diaphragm.

A microspeaker according to the present invention employs the above-described microspeaker diaphragm. And electronic devices according to the present invention incorporate the above-mentioned microspeaker.

### Effect of the Invention

The microspeaker diaphragm edge member of this invention, which employs a construction as described above, excels in heat resistance, cold resistance, moisture resistance, formability (moldability), flex resistance, vibration resistance, and high internal loss property. By incorporating this microspeaker diaphragm edge member into a microspeaker diaphragm or a microspeaker or such a microspeaker into electronic devices such as mobile telephones, mobile audio equipment, and laptop PCs, it is possible to realize microspeaker diaphragms, microspeakers, and electronic devices featuring superior characteristics.

### BRIEF DESCRIPTION OF THE DRAWINGS

FIG. 1 is a diagram for explaining a structure of a microspeaker diaphragm edge member according to the present invention.

FIG. 2A is a diagram showing the chemical structure of polyetheretherketone (PEEK) used in the invention.

FIG. 2B is a table comparing materials in heat resistance characteristic and continuous use temperature.

FIG. 3A is a diagram (1) for explaining an example of a microspeaker diaphragm edge member according to the present invention.

FIG. 3B is a diagram (2) for explaining an example of a microspeaker diaphragm edge member according to the present invention.

FIG. 3C is a diagram (3) for explaining an example of a microspeaker diaphragm edge member according to the present invention.

FIG. 4A is a diagram (1) for explaining another example of a microspeaker diaphragm edge member according to the present invention.

FIG. 4B is a diagram (2) for explaining another example of a microspeaker diaphragm edge member according to the present invention.

FIG. 5 is a configuration diagram of a microspeaker employing the microspeaker diaphragm edge member of FIG. 4.

FIG. 6 is a perspective illustration of a mobile telephone representing conventional technology.

FIG. 7 is a diagram showing a diaphragm representing conventional technology.

FIG. 8 is a structural diagram of a speaker representing conventional technology.

FIG. 9A is a graph showing a relationship between the thickness of the constraining layer and the lowest resonance frequency.

FIG. 9B is a table showing relationships between the thickness of the constraining layers and the lowest resonance frequency.

FIG. 10 is a table showing the values of physical properties of the microspeaker diaphragm edge member.

FIG. 11 shows the results of an endurance test conducted on the microspeaker diaphragm edge member.

### BEST MODE FOR CARRYING OUT THE INVENTION

### <Features of the Present Invention>

The microspeaker diaphragm edge member needs to have not only an adequate failure strength under high heat but also an acoustic characteristic of dissipating as much energy within a dynamic vibration period as practicable. To accomplish that, the microspeaker diaphragm edge member of the present invention features constraining layers on both surfaces of an adhesive layer which provides a suitably high damping effect through efficient dispersion damping. In this constitution known as “constrained layer damping treatment”, the rigidity of the constraining layers must be sufficiently high in relation to the adhesive layer having a high damping effect.

With this constitution employed, the intermediate adhesive layer (damping layer) and both the surface constraining layers tend to deform independently of each other. As a result, the damping layer is subjected to large shear strain. The damping effect per unit weight of the damping material used is far greater than the damping effect required of the constrained layer, and therefore a considerable damping effect can be achieved by the addition of a thin damping layer. Hence, this constitution is well-suited for the microspeaker diaphragm edge member which is required to satisfy light weight and high-output operability.

According to this invention, an acrylic or butyl adhesive material of low hardness is used for the intermediate damping layer, and polyetheretherketone (PEEK), which exhibits high rigidity, heat resistance, and flex resistance, is used for the constraining layers on the respective surfaces of the intermediate layer. Therefore, the resulting microspeaker diaphragm edge member is environment-friendly (containing no RoHS Directive-restricted six substances: lead, cadmium, mercury, hexavalent chromium, PBB, PBDE), has a high internal loss property, excels in heat and cold resistance, and provides a high Young's modulus of the constraining layers. This microspeaker diaphragm edge member is especially well-suited for applications in the speakers of electronic devices such as mobile telephones, mobile audio equipment, and laptop PCs.

Hereinbelow, a description is given of an embodiment of the present invention with reference to accompanying drawings.

### First Embodiment

A description is given of a microspeaker diaphragm edge member of the invention.

As shown in FIG. 1, the microspeaker diaphragm edge member 30 according to this invention has a constitution of an intermediate layer 31 (5 to 50 μm in thickness) formed of an acrylic or butyl low-hardness material sandwiched between constraining layers 32, 33 (2 to 20 μM in thickness) formed of PEEK on both sides thereof.

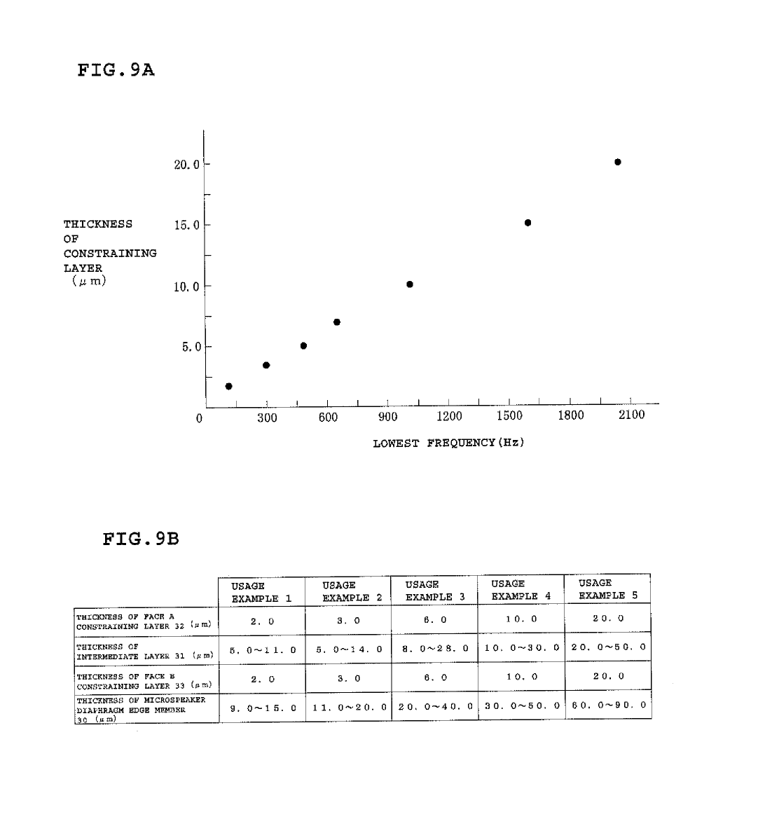

FIG. 9A is a graph showing a relationship between the thickness of the constraining layer 32, 33 and the lowest resonance frequency of the microspeaker. Hereinafter explained is an optimum range of the thickness of the constraining layers 32 and 33.

The horizontal axis of the graph represents the lowest value of the frequency (hereinafter referred to as lowest resonance frequency (Hz)) outputted by the microspeaker employing the above-described microspeaker diaphragm edge member 30, and the vertical axis represents the thickness (μm) of PEEK as the constraining layer 32, 33. Note that the lowest resonance frequency was measured at the thickness of the constraining layer 32, 33 of 2.0 μm, 3.5 μm, 5.0 μm, 7.0 μm, 10.0 μm, 15.0 μm, and 20.0 μm, respectively.

As is evident from FIG. 9A, the lowest resonance frequency increases with the increase in the thickness of the constraining layer 32, 33; that is, the lowest resonance frequency is dependent on the change in the thickness of the constraining layer 32, 33. It can also be seen that the lowest resonance frequency is 100 Hz when the thickness of the constraining layer 32, 33 is 2.0 μm and 2,000 Hz when the thickness of the constraining layer 32, 33 is 20.0 μm.

Here, the lowest resonance frequency of the microspeaker in this embodiment is set at 100 Hz or above. This is because, as is clear from FIG. 9A, the thickness of the constraining layer 32, 33 must be 2.0 μm or less if the lowest resonance frequency is to be below 100 Hz. But there will be greater possibilities of rupture or other damage if the constraining layers 32 and 33 are made thinner than 2.0 μm. Also, the lowest resonance frequency of the microspeaker in this embodiment is set at below 2,000 Hz. This is because the lowest resonance frequency, if set at 2,000 Hz or above, may allow reproduction of sounds in the high-pitched sound range of 2,000 Hz or above, but will hamper the reproduction of sounds in the low-pitched sound range of below 2,000 Hz, thus spoiling the performance of the speaker. For reasons as described above, the appropriate thickness of PEEK alone as the constraining layer 32, 33 is in the range of 2.0 to 20.0 μm.

Next, the optimum range of the thickness of the intermediate layer 31 is determined by the relationship between the thickness of the intermediate layer 31 and the internal loss of the diaphragm. It is to be noted that the internal loss in this case is, roughly speaking, an indicator of suppressed vibrancy of sounds. That is, the greater the internal loss is, the less likely the reverberation may occur within the speaker. The internal loss increases along with the increase in the thickness of the intermediate layer 31; it is dependent on the change in the thickness of the intermediate layer 3. Accordingly, the choice of a thicker intermediate layer 31 may increase the internal loss, which in turn may produce a speaker with less reverberation. However, the greater thickness of the intermediate layer 31 may lead to the loss of its formability and may disturb the thickness balance with the constraining layers 32, 33 in the microspeaker diaphragm edge member 30. Hence, the thickness of the intermediate layer 31 must be such as to retain minimal formability and achieve higher internal loss. Therefore, the range of thickness of the intermediate layer 31 in this embodiment is set at 5.0 to 50.0 μm in view of its intended application to the microspeaker.

FIG. 9B is a table showing usage examples of the microspeaker diaphragm edge member 30. Hereinbelow, possible thickness combinations are outlined when the thickness of the intermediate layer 31 is in the range of 5.0 to 50.0 μm and the thickness of the constraining layer 32, 33 is in the range of 2.0 to 20.0 μm.

As shown in the figure, Usage example 1 is a microspeaker diaphragm edge member 30 used in an earphone or the like, of which the thickness of the face A constraining layer 32 and the face B constraining layer 33 is both 2.0 μm. In this case, the thickness of the intermediate layer 31 is restricted into a range of 5.0 to 11.0 μm, and the thickness of the microspeaker diaphragm edge member 30 (total of the intermediate layer 31 and the constraining layers 32 and 33) will be in a range of 9.0 to 15.0 μm.

Also, Usage example 4 is a microspeaker diaphragm edge member 30 used in a laptop PC or the like, of which the thickness of the face A constraining layer 32 and the face B constraining layer 33 is both 10.0 μm. In this case, the thickness of the intermediate layer 31 is restricted into a range of 10.0 to 30.0 Ka, and the thickness of the microspeaker diaphragm edge member 30 (total of the intermediate layer 31 and the constraining layers 32, 33) will be in a range of 30.0 to 50.0 μm.

As described above, the thicknesses of the intermediate layer 31 and the constraining layers 32 and 33 are determined as appropriate according to the type and application of the speaker.

The hardness of the intermediate layer 31 is set at A60 or below as measured by a Shore type A durometer. The Shore type A durometer used herein is a tester for determining the hardness of a material by measuring the amount of deformation (depth of an indentation) made in its surface by a presser foot which is pressed into it (JIS K 6253) Thus, the intermediate layer 31, whose hardness is set at Shore A 60 or below, is flexible. Therefore, even when sandwiched between the constraining layers 32 and 33 of highly rigid PEEK, the intermediate layer 31 can realize a microspeaker diaphragm edge member 30 featuring high elasticity and flexibility.

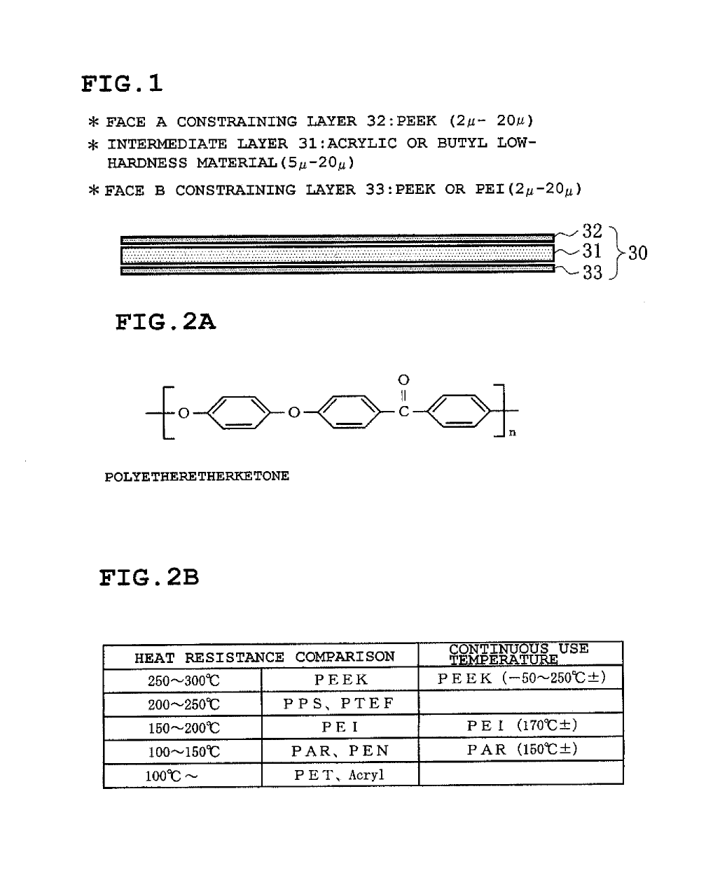

To produce a microspeaker diaphragm edge member according to the present invention, PEEK of the chemical structural formula as shown in FIG. 2A is first formed into a sheet, and then an intermediate layer of an acrylic or butyl low-hardness material held by the PEEK sheet on each side of it is molded in a hot press. As a result, a microspeaker diaphragm edge member 30 consisting of three layers of an intermediate layer 31 of an acrylic or butyl low-hardness material and constraining layers 32 and 33 of PEEK on the respective faces of the intermediate layer 31, as shown in FIG. 1, is obtained.

The microspeaker diaphragm edge member 30 manufactured in this manner features superior characteristics of heat resistance, cold resistance, moisture resistance, formability, and high internal loss in comparison with the conventional edge members.

The acrylic or butyl low-hardness material 31 constituting the intermediate layer is an adhesive layer having a high damping effect. The PEEK constituting the constraining layers 32 and 33 on the respective faces not only provides rigidity, high flex resistance and failure strength, but also features higher heat resistance and wider temperature range for continuous use than other materials as is evident from the comparison table of FIG. 2B. Hence, these materials are well-suited for the microspeaker diaphragm edge member which excels in heat resistance, cold resistance, moisture resistance, formability, and high internal loss property.

When a high priority is to be put on formability (moldability), the arrangement may be such that PEEK, which excels in heat resistance, is used for the constraining layer 32 on one face only, and PEI, which shows superior formability and small thermal contraction, is used for the constraining layer 33 on the opposite face (see FIG. 1).

In FIG. 2B, note that PEEK stands for polyetheretherketone, PTEF fluorocarbon polymer, PPS polyphenylene sulfide resin, PEI polyetherimide, PAR polyarylate, PEN polyethylene naphthalate, and PET polyethylene terephthalate.

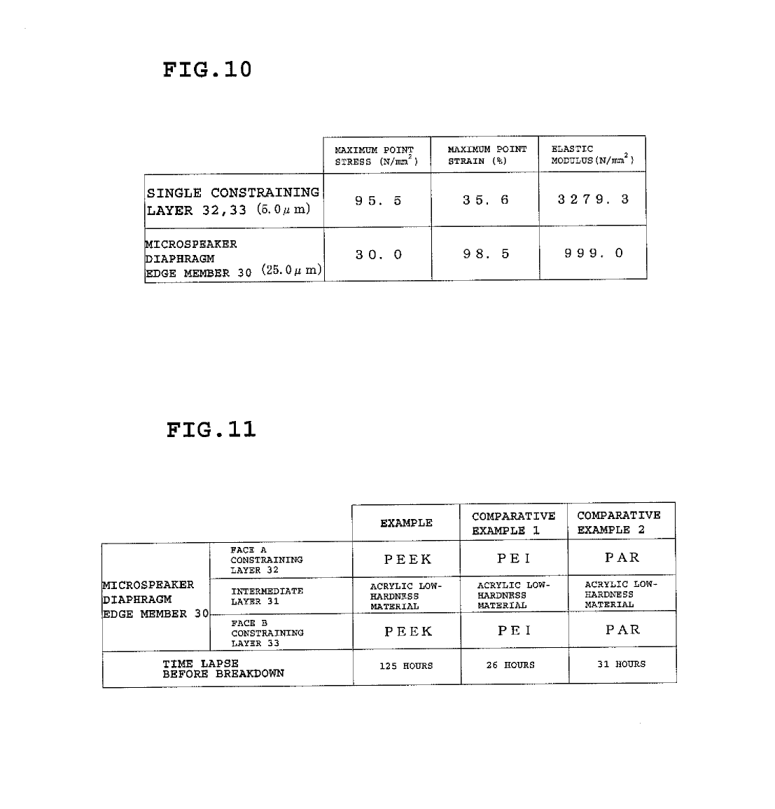

FIG. 10 is a table showing a comparison of physical property values between the constraining layer 32, 33 and the microspeaker diaphragm edge member 30. In the table of FIG. 10, the constraining layers 32 and 33 are both formed of 5.0 μm thick PEEK, and the maximum point stress, the maximum point strain, and the modulus of elasticity of the constraining layer 32, 33 are 95.5 N/mm², 35.6% and 3279.3 N/mm², respectively. Also, the microspeaker diaphragm edge member 30 is of a three-layer construction consisting of a 15.0 μm thick intermediate layer 31 and constraining layers 32 and 33 of 5.0 μm thick PEEK each. The maximum point stress, the maximum point strain, and the modulus of elasticity of the microspeaker diaphragm edge member 30 are 30.0 N/mm², 98.5% and 999.0 N/mm², respectively.

Note that the “maximum point stress” is the maximum value of a force occurring inside per unit area of an object. The smaller the value of the maximum point stress, the higher the flexibility of the object is. Also, the “maximum point strain” is the rate of positional change when an external force is applied to an object. The larger the value of the maximum point strain, the higher the failure resistance of the object is. Further, the “modulus of elasticity”, which is also referred to as Young's modulus, is a value showing a ratio of stress to strain. The smaller the value of the modulus of elasticity, the softer the material of the object is.

As is clear from these results, the microspeaker diaphragm edge member 30 of a three-layer construction has markedly lower maximum point stress and modulus of elasticity than the constraining layer 32, 33 formed of PEEK. This fact is considered attributable to the use of an intermediate layer 31 of an acrylic or butyl low-hardness material whose hardness is Shore A 60 or below.

Also, it can be seen that the microspeaker diaphragm edge member 30 of a three-layer construction has markedly higher maximum point strain than the constraining layer 32, 33 formed of PEEK. This fact is considered attributable to the structure of the intermediate layer 31 sandwiched from both sides by the constraining layers 32 and 33 of highly rigid PEEK.

As a result, it has been confirmed that the microspeaker diaphragm edge member 30 having a three-layer construction of the intermediate layer 31 sandwiched between the constraining layers 32 and 33 provides fairly excellent characteristics of flexibility, elasticity, flex resistance, and failure resistance.

Hereinbelow, a description is given of an endurance test conducted on a microspeaker diaphragm edge member 30 with reference to FIG. 11. The test conditions were as follows.

Test conditions:

### Temperature: 90° C.

### Frequency: 100 Hz

Test method: Microspeaker diaphragms 300 were constructed using their respective microspeaker diaphragm edge members 30. They were placed under the above temperature and frequency conditions, and time was measured until their microspeaker diaphragm edge members 30 broke down.

In the table of FIG. 11, an Example of the microspeaker diaphragm edge member 30 was of a three-layer construction consisting of an intermediate layer 31 of an acrylic low-hardness material and constraining layers 32 and 33 of PEEK on their respective faces of the intermediate layer 31.

In contrast to this, Comparative Example 1 of the microspeaker diaphragm edge member 30 was of a three-layer construction consisting of an intermediate layer 31 of an acrylic low-hardness material and constraining layers 32 and 33 of PEI. Also, Comparative Example 2 of the microspeaker diaphragm edge member 30 was of a three-layer construction consisting of an intermediate layer 31 of an acrylic low-hardness material and constraining layers 32 and 33 of PAR.

As is clear from the results shown in the table, the time lapse before breakdown of the Example of the microspeaker diaphragm edge member 30 was 125 hours. In contrast to this, the time lapse before breakdown of Comparative Examples 1 and 2 of the microspeaker diaphragm edge member 30 was 26 hours and 31 hours, respectively.

Thus it can be seen that the Example of the microspeaker diaphragm edge member 30 displayed a markedly longer time lapse before breakdown than the Comparative Examples 1 and 2 of the microspeaker diaphragm edge member 30. This is attributable to the far superior heat resistance and flex resistance of PEEK constituting the constraining layers 32 and 33 to those of PHI and PAR.

From these results, it has been confirmed that the choice of PEEK having superior rigidity, heat resistance, and flex resistance for the constraining layers 32 and 33 can produce a microspeaker diaphragm edge member 30 which excels in heat resistance, cold resistance, formability, flex resistance, vibration resistance, and flexibility.

### Second Embodiment

Hereinbelow, a description is given of embodiments of a microspeaker diaphragm employing a microspeaker diaphragm edge member having the above-described superior characteristics and a microspeaker incorporating such a microspeaker diaphragm with reference to drawings.

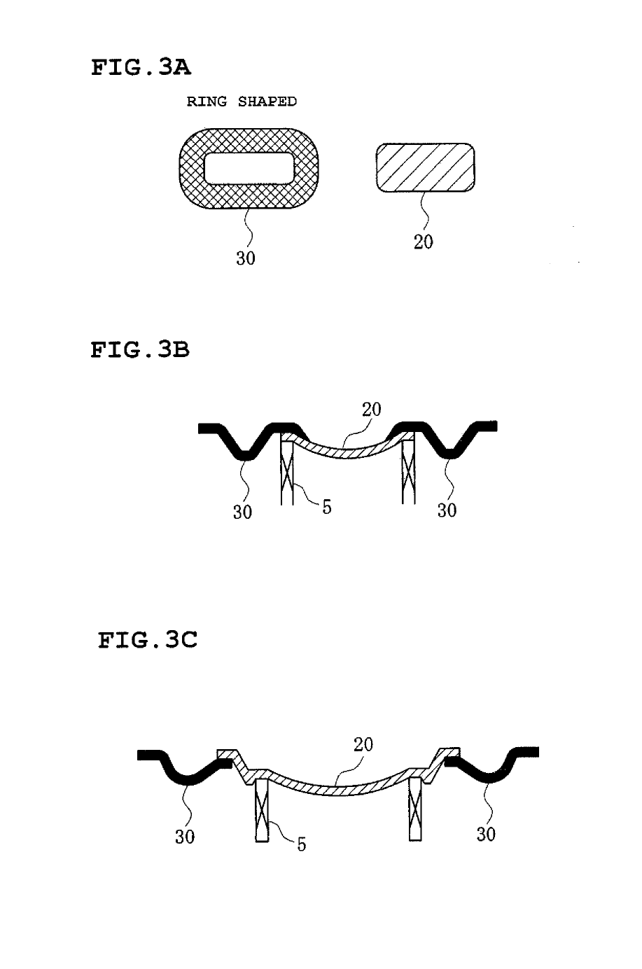

FIGS. 3A and 3B are diagrams for explaining an example of a diaphragm employing a microspeaker diaphragm edge member according to the present invention.

In FIG. 3A, the highly-elastic member 20 is formed of paper, engineering plastic film, or aluminum, magnesium, or other light-metal sheet, and the microspeaker diaphragm edge member 30 is of a construction explained in the first embodiment which has constraining layers of PEEK.

The microspeaker diaphragm edge member 30 in this embodiment, which is ring-shaped, is integrally molded with the highly-elastic member 20 after its inner peripheral portion is so positioned as to overlap with the outer peripheral portion of the highly-elastic member 20.

The highly-elastic member 20 and the microspeaker diaphragm edge member 30 are integrally molded together in such positional relationship that the highly-elastic member 20 mainly forms the dome part, or body part, of the diaphragm and the microspeaker diaphragm edge member 30 mainly forms the peripheral part, or edge part, of the diaphragm, and then they are incorporated into a microspeaker.

The arrangement may be such that an adhesive or bonding capability is given in advance to at least one of the highly-elastic member 20 and the microspeaker diaphragm edge member 30 (by application of an adhesive or by use of some material characteristic that causes bonding at the time of integral molding). Then, at the integral molding, the highly-elastic member 20 and the microspeaker diaphragm edge member 30 are bonded together, thereby producing a microspeaker diaphragm in an edge-free type (Ultra Linear type).

FIG. 3B is a configuration diagram showing a microspeaker diaphragm edge member 30 which has been integrally molded as described above and attached to a voice coil of a microspeaker. Shown in FIG. 3B is an example of a microspeaker diaphragm edge member 30 disposed above a highly-elastic member 20. Contrary to this, it is possible that a microspeaker diaphragm edge member 30 is disposed below a highly-elastic member 20 as shown in FIG. 3C. Whether the position of FIG. 3B or the position of FIG. 3C is used is determined in consideration of the structure of the microspeaker. It goes without saying that an optimum shape should be selected as the shape of the mold in the integral molding.

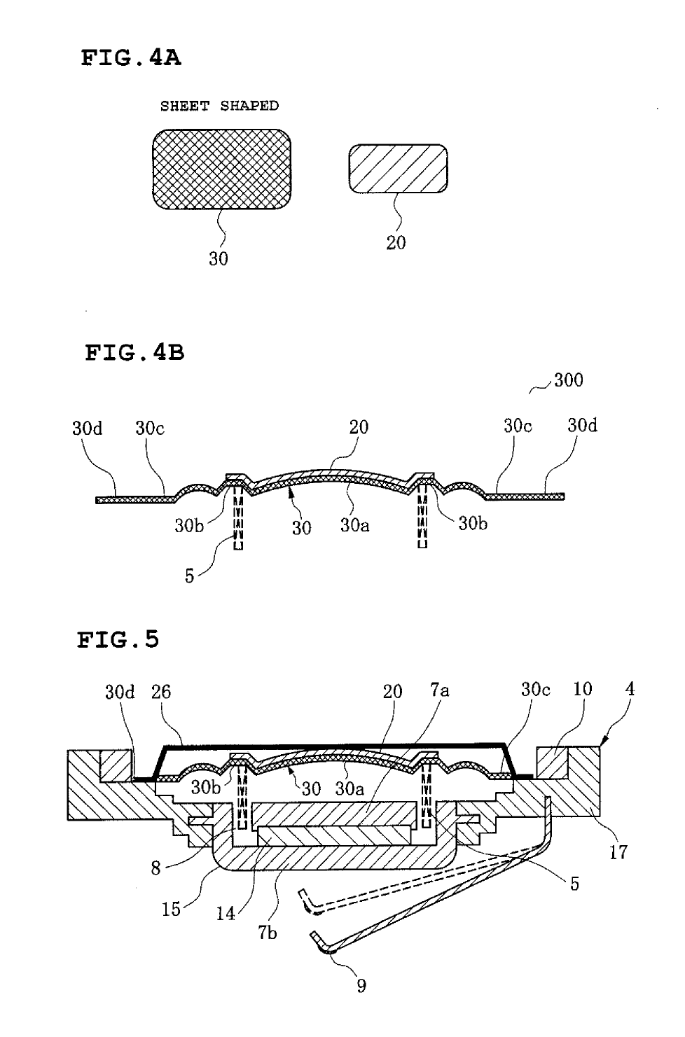

FIGS. 4A and 4B are diagrams showing another example of a diaphragm according to the present invention.

In FIG. 4A, the highly-elastic member 20 is formed of paper, engineering plastic film, or aluminum, magnesium, or other light-metal sheet. And the microspeaker diaphragm edge member 30 is integrally molded with the highly-elastic member 20 in such positional relationship that the highly-elastic member 20 placed on the sheet of the microspeaker diaphragm edge member 30 is located in the dome part, or body part, of the diaphragm (normally in the center).

In this case, the highly-elastic member 20 forms the dome part, or body part, of the diaphragm, and the microspeaker diaphragm edge member 30 forms both the dome part, or body part, and peripheral part, or edge part, of the diaphragm. In other words, the dome part of the diaphragm is formed by the part of the highly-elastic member 20 and the microspeaker diaphragm edge member 30 overlapping each other, and the peripheral part of the diaphragm is formed by the microspeaker diaphragm edge member 30 only.

In this case, too, an adhesive or bonding capability is given in advance to at least one of the highly-elastic member 20 and the microspeaker diaphragm edge member 30 (by application of an adhesive or by use of some material characteristic that causes bonding at the time of integral molding). Then, in the integral molding, the highly-elastic member 20 and the microspeaker diaphragm edge member 30 are bonded together, thereby producing a microspeaker diaphragm in an edge-free manner.

FIG. 4B and FIG. 5 are diagrams showing a microspeaker diaphragm manufactured as described above and a microspeaker employing the microspeaker diaphragm, respectively.

In FIG. 4B, the microspeaker diaphragm 300 is a microspeaker diaphragm produced by bonding and molding a highly-elastic member 20 and a microspeaker diaphragm edge member 30 together. The microspeaker diaphragm 300 includes a dome part (body) 30a thereof, a fitting cavity 30b thereof, a peripheral part (edge) 30c thereof, and an outer bonding part 30d thereof. The dome part (body) 30a of the diaphragm is formed of a double layer of the highly-elastic member 20 and the microspeaker diaphragm edge member 30, whereas the peripheral part (edge) 30c and outer bonding part 30d of the diaphragm are formed of the microspeaker diaphragm edge member 30 only. The reference numeral 5 denotes a voice coil of a speaker. The sheet side of the microspeaker diaphragm edge member 30 is installed in contact with the voice coil 5.

FIG. 5 is a diagram showing a structure of a speaker section incorporating the diaphragm 300 shown in FIG. 4B. In the figure, the speaker section includes a microspeaker diaphragm edge member 30, a dome part (body) 30a of the diaphragm, a fitting cavity 30b of the diaphragm, a peripheral part (edge) 30c of the diaphragm, an outer bonding part 30d of the diaphragm, a speaker 4 employing the diaphragm (corresponding to the speaker 2 in FIG. 8), a voice coil 5, an upper pole plate 7a of the speaker, a lower pole plate 7b of the speaker, a magnetic gap 8, an external terminal 9 of the speaker, a gasket 10, a magnet 14 of the speaker, a magnetic circuit 15 of the speaker, a frame 17, and a protector 26. FIG. 5 differs from FIG. 8 in the structure of the diaphragm, and otherwise is the same as FIG. 8.

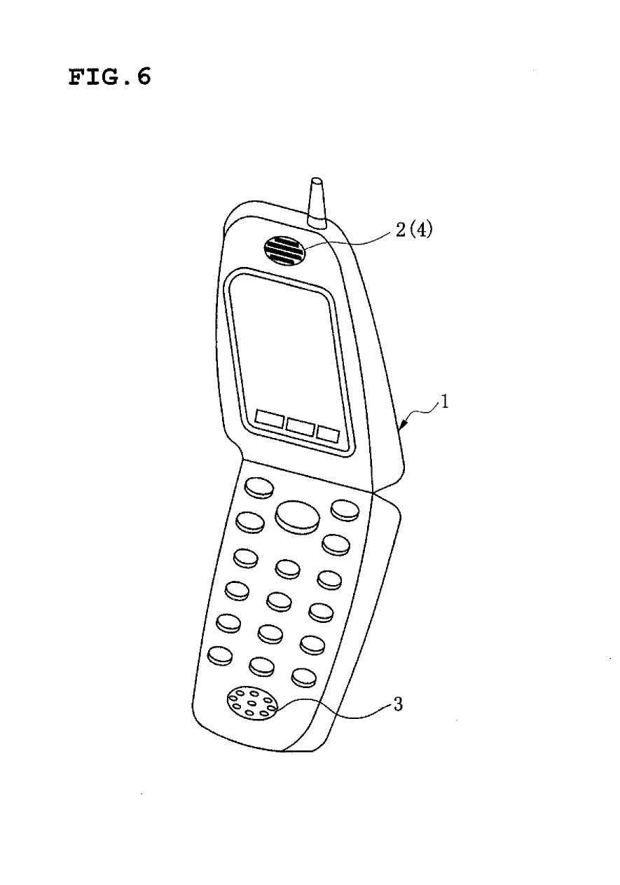

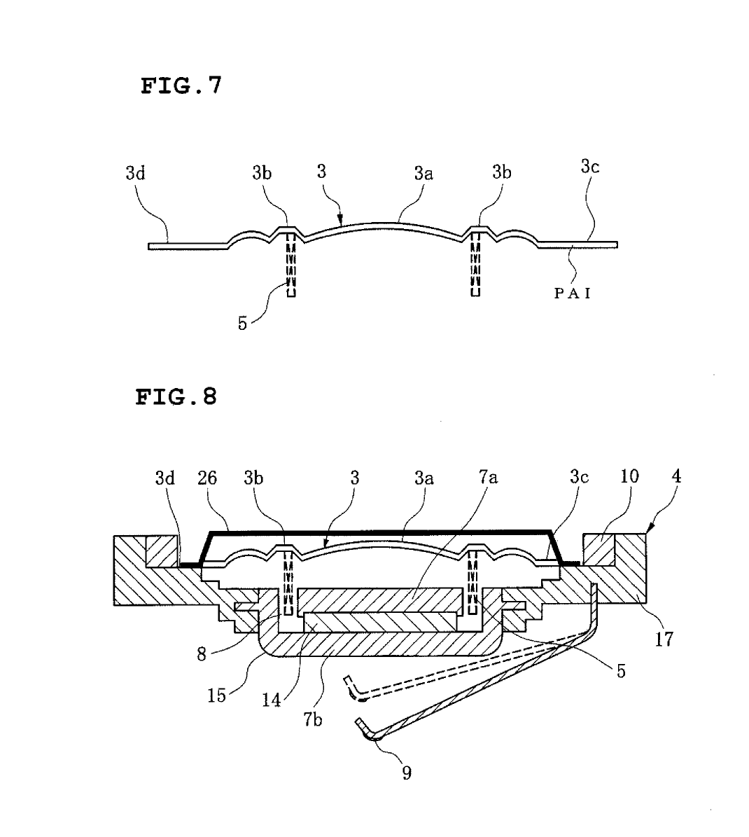

In a conventional technology explained with reference to FIGS. 6 to 8, the peripheral part (edge) and the dome part (body) of the microspeaker diaphragm are integrally molded from an engineering plastic film of the same material. In such a case, it is difficult to design the diaphragm to have a lower lowest resonance frequency (F0) of the speaker, and the diaphragm tends to have less than enough reproducible lower limit frequencies and produce harder sounds. In another conventional method, the peripheral part (edge) and the dome part (body) of the diaphragm are molded separately and then bonded together. In this case, a problem to be solved is in balancing between the low-tone range reproduction and the input (stressing the low-tone range reproduction will make the input smaller, and stressing the input will compromise the low-tone range reproduction), in addition to the problem of low productivity. In the present invention, however, a highly-elastic member (formed of paper, engineering plastic film, or aluminum, magnesium, or other light-metal sheet) and a microspeaker diaphragm edge member described in the first embodiment are integrally bonded and molded together. As a result, this highly productive and easy method realizes a diaphragm exhibiting superior low-tone range reproduction and applicable to the high-output speaker.

### INDUSTRIAL APPLICABILITY

The microspeaker diaphragm edge member according to the present invention excels in heat resistance, cold resistance, moisture resistance, formability (moldability), and high internal loss property. Therefore, it can serve the application of the microspeaker edge member for electroacoustic transducers used in electronic devices such as mobile telephones, mobile audio equipment, and laptop PCs and all other electronic devices using speakers.

### DESCRIPTION OF REFERENCE NUMERALS

1 mobile telephone
2 speaker employing diaphragm
20 highly-elastic member (paper, engineering plastic film, or aluminum, magnesium, or other light-metal sheet)
30 microspeaker diaphragm edge member
31 intermediate layer (acrylic or butyl low-hardness material)
32, 33 constraining layer (PEEK: polyetheretherketone)
3a, 30a dome part (body) of diaphragm
3b, 30b fitting cavity of diaphragm
3c, 30c peripheral part (edge) of diaphragm
3d, 30d outer bonding part of diaphragm
300 diaphragm
4 microspeaker employing diaphragm
5 voice coil
7a upper pole plate of speaker
7b lower pole plate of speaker
8 magnetic gap
9 external terminal of speaker
10 gasket
14 magnet of speaker
15 magnetic circuit of speaker
17 frame
26 protector

1. A microspeaker diaphragm edge member comprising:
an intermediate layer having a high damping effect;
a constraining layer of polyetheretherketone (PEEK) disposed on one face of the intermediate layer; and
a constraining layer of polyetheretherketone (PEEK) or polyetherimide (PEI) disposed on the other face of the intermediate layer.

2. The microspeaker diaphragm edge member according to claim 1, wherein the constraining layers on the respective faces of the intermediate layer are both formed of PEEK and wherein the thickness of each constraining layer is in a range of 2.0 to 20.0 μm.

3. The microspeaker diaphragm edge member according claim 1, wherein the thickness of the intermediate layer is in a range of 5.0 to 50.0 μm.

4. The microspeaker diaphragm edge member according claim 1, wherein the intermediate layer is formed of an acrylic or butyl low-hardness material.

5. The microspeaker diaphragm edge member according to claim 1, wherein the hardness of the intermediate layer is Shore A 60 or below.

6. A microspeaker diaphragm employing a microspeaker diaphragm edge member as recited in claim 1.

7. A microspeaker diaphragm employing a microspeaker diaphragm edge member as recited it claim 1, comprising:
a dome part (body part) formed of a highly-elastic member; and
a ring-shaped peripheral part (edge part) formed of the microspeaker diaphragm edge member,
wherein the dome part and the peripheral part are integrated with each other in such a positional relationship that an outer peripheral portion of the highly-elastic member is overlapped with an inner peripheral portion of the ring-shaped microspeaker diaphragm edge member.

8. A microspeaker diaphragm employing a microspeaker diaphragm edge member as recited in claim 1 comprising:
a highly-elastic member forming a dome part (body part) of the diaphragm;
wherein the microspeaker diaphragm edge member is sheet-shaped the edge member forming both the dome part (body part) and peripheral part (edge part) of the diaphragm,
wherein the highly-elastic member and the sheet-shaped microspeaker diaphragm edge member are integrated with each other in such position that the highly-elastic member overlaps the sheet-shaped microspeaker diaphragm edge member in the dome part (body part) of the diaphragm.

9. A microspeaker employing a microspeaker diaphragm as recited in claim 6.

10. An electronic device incorporating a microspeaker as recited in claim 9.
